(19) United States
(12) Patent Application Publication
(10) Pub. No.: US 2025/0037441 A1
(43) Pub. Date: Jan. 30, 2025

(54) ONLINE DOMAIN ADAPTATION

(71) Applicant: Five AI Limited, Cambridge (GB)

(72) Inventors: Malik Boudiaf, Montreal (CA); Luca Bertinetto, Oxford (GB)

(73) Assignee: Five AI Limited, Cambridge (GB)

(21) Appl. No.: 18/710,560

(22) PCT Filed: Nov. 15, 2022
(86) PCT No.: PCT/EP2022/082033

§ 371 Date: May 15, 2024

(30) Foreign Application Priority Data
Nov. 16, 2021 (GB) 2116512.1

(51) Int. Cl. G06V 10/778; G06V 10/75; G06V 10/774; G06V 10/776; G06V 20/40; G06V 20/70

(52) U.S. Cl. CPC G06V 10/778; G06V 10/75; G06V 10/7753; G06V 10/776; G06V 20/41; G06V 20/70

(57) ABSTRACT

The problem of domain shift error in computer vision models and other perception components is addressed. In a label approximation phase, an approximate label distribution is computed for each input of a target batch using a trained machine learning (ML) perception component. In an online label optimization phase, a modified label distribution is assigned to each input of the target batch, via optimization of an unsupervised loss function that (i) penalizes divergence between the approximate label distribution and the modified label distribution for each input of the target batch (ii) penalizes deviation between the modified label distributions assigned to input pairs of the target batch having similar features.

### TECHNICAL FIELD

The present disclosure addresses problems concerning domain shifts in machine learning. A practical context considered herein is that of perception (encompassing image processing and other sensor modalities, such as lidar and radar), which has applicability to autonomous driving and robotics more generally. In this context, domain shifts can impact the real-world performance of a perception system supporting higher-level functions (such as prediction and motion planning).

### BACKGROUND

A typical (and sometimes implicit) assumption in supervised machine learning is that samples (x, y)∈X×Y used in model training are drawn i.i.d. (independent and identically distributed) from some distribution D_{S} over X×Y, where D_{S} is referred to as the source domain. Here, x denotes an input and y denotes its label or class (those terms being used interchangeably herein). The objective is to learn some function ƒ: X→Y (the model) that generalizes to other examples in the source domain, in the sense of minimizing the model's labelling error on other samples drawn from the same distribution D_{S}. The model may be defined by a set of parameters θ whose values are learned in training.

Domain shift errors arise when applying such a model to other domains. Such errors are caused by discrepancies between the example inputs used in training and the inputs encountered by the model when it is deployed (or, more precisely, a difference in the data distribution of the model's training set and the data distribution of some data set it encounters once deployed). Domain adaptation methods seek to transfer learning from a source domain(s) D_{S} to some desired target domain D_{T}, in order to improve performance on the target domain with reduced additional training burden (without having to retrain the model “from scratch” on the target domain). A subset of domain adaptation techniques do not require access to the source training set itself.

A perception component refers generally to a machine learning model that is capable of perceiving physical structure captured in an input. One example of a perception component is a suitably trained convolutional neural network. In computer vision applications, such inputs may take the form of images. However, the techniques described herein can also be applied to other forms of input (such as point clouds, voxel tensors, surface meshes, or any other input in which perceivable physical structure is captured etc.). Such inputs may capture physical structure in two or three spatial dimensions. The output of a classification-based perception component may take the form of a class or label distribution (probabilistic or score-based classification over a given set of structure classes or labels).

In a perception context, domain shifts can occur, for example, when training inputs have been captured under particular weather or lighting conditions, or in particular geographic regions (e.g. a city with particular architectural characteristics). Such problems are particularly acute in an autonomous driving context, as there may be practical limitations on the extent and variation of training data that can feasibly be gathered by sensor-equipped vehicles.

### SUMMARY

The problem of domain shift error in computer vision models and other perception components is addressed herein. In that context, a machine learning model exhibiting domain shift errors takes the form of a perception component.

A first aspect herein is directed to a computer-implemented method of classifying inputs of a target batch, the method comprising: in a label approximation phase, computing an approximate label distribution for each input of the target batch using a trained machine learning (ML) model, the trained ML model having parameters learned from training on a source training set, the approximate label distribution exhibiting error caused by a domain shift between the source training set and the target batch; in an online label optimization phase, assigning a modified label distribution to each input of the target batch, via optimization of an unsupervised loss function, the unsupervised loss function comprising: (i) a first term that penalizes divergence between the approximate label distribution and the modified label distribution for each input of the target batch, and (ii) a second term that penalizes deviation between the modified label distributions assigned to input pairs of the target batch having similar features. The first and second terms are aggregated over the target batch, with the objective of finding a set of modified label distributions that overall optimizes the unsupervised loss function across the target batch.

A benefit of the method is that it can be applied to an unlabelled and non-i.i.d. target batch, without requiring any access to the source training set used to train the ML model. Because the target batch does not need to be “curated” in the same way as a training set, the method can be applied highly effectively to real and highly-correlated inputs (such as nearby frames of a video sequence) in an online/runtime context (e.g. within a perception stack of an autonomous vehicle or other robotic system).

Expanding on the preceding paragraph, the optimization is specific to the target batch to improve the label distributions for that target batch: the optimization is of the labels (the model outputs) computed for a given target batch, rather than the model itself (as opposed to other domain adaptation methods that seek to adapt a model to a target domain so that it can generalize to other inputs drawn from the target domain).

Note, the loss function is a function of the modified label distributions (the variables of the loss function) and the modified label distributions are tuned to optimize the loss function. This is different from a typical model training application, where a loss function would instead be formulated as a function of the model parameters and the model parameters would be tuned to optimize the loss.

As such, the method does not rely on any assumption as to how the target batch is drawn from the target domain, and in particular does not assume the target batch is i.i.d.

Moreover, in contrast to semi-supervised techniques that learn from partially labelled/annotated data, the method does not require any ground truth labels for the inputs in the source set; the only assumption is that inputs within similar features should have similar label distributions, which does not require any ground truth labels to enforce.

The method may be performed without modifying any parameter of the ML model.

In the described embodiments, the target batch is unlabelled and the unsupervised loss function does not comprise any supervised term.

The method may be applied separately to multiple target batches, in order to optimize the respective labels for each target batch independently. In contrast to other domain adaptation methods, the ML model itself is “frozen” (in that none of its parameters is modified based on the target batch).

In embodiments, the ML model may comprise a feature extractor that computes a feature set for each input, the feature set used to compute the approximate feature distribution, and the second term of the loss function may penalize deviation between the modified label distributions assigned to input pairs of the target batch having similar feature sets as computed by the feature extractor.

The loss function may be defined as

$${ℒ}^{LAME} ( \tilde{Z} ) = {\sum }_{i} KL ( {\tilde{z}}_{i} ‖ {p}_{i} ) - {\sum }_{i , j} {w}_{ij} {\tilde{z}}_{i}^{T} {\tilde{z}}_{j}$$

where \tilde{Z} denotes the modified label distributions across the target batch, \tilde{z}ᵢ is the modified label distribution for input i, pᵢ is the approximate label distribution, and wᵢⱼ=w(ϕ(xᵢ), ϕ(xⱼ)), where ϕ(x) denotes the feature set for input x.

The modified label distribution may be computed iteratively, wherein in iteration n+1, the modified label distribution is computed based on the previous iteration n as:

$${\tilde{z}}_{ik}^{( n + 1 )} = \frac{{p}_{s} ( k \vert {x}_{i} ) exp ( - {\sum }_{j} {w}_{ij} {\tilde{z}}_{jk}^{( n )} )}{{\sum }_{{k}^{′}} {p}_{s} ( {k}^{′} \vert {x}_{i} ) exp ( - {\sum }_{j} {w}_{ij} {\tilde{z}}_{{jk}^{′}}^{( n )} )}$$

where k denotes a class and pₛ(k|xᵢ) is the probability of xᵢ belonging to class k according to the approximate label distribution.

The perception inputs are correlated perception inputs receives in an input stream.

The perception inputs may be correlated perception inputs received in at least one sensor data stream. For example, the perception inputs may be correlated images received in at least one video stream.

Further aspects herein provide a computer system comprising one or more computers configured to implement the above method or any embodiment thereof, and computer program code for programming a computer system to implement the same.

### BRIEF DESCRIPTION OF FIGURES

Embodiments will now be described by way of example only, with reference to the following figures, in which:

FIG. 1 shows a schematic block diagram of an image processing system incorporating a label modifier; and

FIGS. 2 to 7 document the result of experiments described herein.

### DETAILED DESCRIPTION

Training state-of-the-art computer vision models has become prohibitively expensive for many researchers and practitioners. For the sake of accessibility and resource reuse, it is important to focus on adapting these models to a variety of downstream scenarios. An interesting and practical setup is online “fully test-time adaptation”, according to which training data is inaccessible, adaptation can only happen at test time and on a handful of data, and no labelled data from the test distribution is available.

Herein, test-time adaptation methods are applied to a number of pre-trained models on a variety of real-world scenarios, significantly extending the way they have been originally evaluated. It is demonstrated that such models only perform well in narrowly-defined experimental setups and fail, sometimes catastrophically, when their hyperparameters are not carefully selected. Motivated by the inherent uncertainty around the conditions that will ultimately be encountered at test time, a particularly “conservative” approach is described herein, which addresses the problem with a Laplacian Adjusted Maximum-likelihood Estimation (LAME) objective. By virtue of only adapting the model's output (and not its parameters), this approach exhibits a much higher average accuracy across scenarios than existing methods, while also being notably faster and requiring a much lower memory footprint.

### 1. Introduction

In recent years, training state-of-the-art models has become a massive computational endeavour for many machine learning problems, especially in computer vision and natural language processing (e.g. [4,12,39]). For instance, it has been estimated that each training of GPT-3 [4] produces an equivalent of 552 tons of CO2, which is approximately the amount emitted in six flights New York→San Francisco [36]. As implied in the multidisciplinary whitepaper on “foundation models” [3], it is therefore reasonable to expect that more and more efforts will be dedicated to the design of procedures that allow for the efficient adaptation of previously-trained large models under a variety of circumstances. In other words, these models will be “trained once” on a vast dataset and then adapted at test time (potentially with no labels) to newly-encountered scenarios. Besides being important for resources reuse, being able to abstract the pre-training stage away from the adaptation stage is paramount in privacy-focused applications, and in any other situation in which preventing access to the training data is desirable. To achieve this goal, it is important that, from the point of view of the adaptation system, there is no access to the training data or to the training procedure of the model to adapt. With this context in mind, a need arises for adaptation methods ready to be used in realistic scenarios, and for a variety of models.

One aspect that many real-world applications have in common is the need of performing adaptation online, and with a limited amount of data. That is, it should be possible to perform adaptation while the data is being received. Take for instance the vision model with which an autonomous vehicle or a drone may be equipped. At test-time, it will ingest a video stream of highly-correlated data (non-i.i.d.), which could be used for quick adaptation. It is important to be confident that leveraging this information will be useful, and not destructive, no matter the type of domain shift that may exist between training and test data. Such shifts could be, for instance, “low-level” (e.g. the data stream is affected by a snowy weather which has never been encountered during a California-sunlit training stage), or “high-level” (e.g. the data includes the particular Art Deco architecture of Miami Beach's Historic District), or even a combination of both.

Motivated by the above considerations, a testtime adaptation system is described that 1) is unsupervised; 2) can operate online and on potentially non-i.i.d. data; 3) assumes no knowledge of training data or training procedure; and 4) is not tailored to a certain model, so that the progress made by the community can be directly harnessed.

This problem falls under the fully testtime adaptation scenario studied in a handful of recent works [28, 30, 56], where simple techniques such as testtime learning of batchnorm's scale and bias [56] via backpropagation have proven to be effective in scenarios such as the low-level corruptions of ImageNet-C [17].

Experimental results are presented herein, which demonstrate that existing methods [26, 28, 30, 56] are not very indicated for uncertain yet realistic situations because of their sensitivity to variables such as the model to adapt or the type of domain shift encountered. It is demonstrated that, when selecting their hyperparameters to maximize the average accuracy over a number of scenarios, existing methods all fare worse than a non-adaptive baseline. For them to perform well, it is essential that their hyperparameters are chosen under the same conditions encountered at test time. However, this is clearly not an option when the test-time conditions are unknown in advance.

These findings suggest that, when being agnostic to both training and testing circumstances is important, it is wise to approach the problem of test-time adaptation prudently. Hence, instead of adapting the parameters of a pre-trained model, the described embodiments only adapt its output by finding the latent assignments that optimize a regularized maximum likelihood of the observed data. Due to its recent success in (transductive) few-shot learning [64], Laplacian regularization [1, 63] is used—which encourages closer points in the embedding space to be labelled similarly—as the corrective term of the regularized objective. When aggregating over different conditions, this simple and “conservative” strategy significantly improves both over the non-adaptive baseline and existing test-time adaptation methods in an extensive set of experiments covering 7 datasets, 19 shifts, 3 training strategies and 5 architectures. Moreover, by virtue of not performing model adaptation but only output correction, it reduces by half both the total inference time and the memory footprint compared to existing methods.

### 2. Related Work

In general, domain adaptation aims at relaxing the simplifying assumption for which “train and test distributions should match”, which is at the foundation of most machine learning algorithms. Since real-world applications can rarely operate under the textbook assumption, this relaxation understandably generated a lot of interested and motivated a large corpus of work.

Early works in domain adaptation were fairly simplistic, in that they required access, during training, to at least some labelled samples drawn from the target domain [35]. Unsupervised domain adaptation [59] makes the scenario slightly more applicable by incorporating the samples originating from the target domain without requiring any label. Two common general strategies are, for instance, to try and learn domain-invariant feature representations by minimizing some measure of divergence between source and target distributions (e.g. [20,31,50]); or embedding a “domain discriminator” component in the network and then penalizing its success in the overall loss (e.g. [14, 38]). Still, the necessity of having access, during training, to both source and target domains limits the usability of this class of methods. Domain generalization (DG) foregoes the need of accessing to the target distribution by learning a model from a number of domains, with the intent of generalizing to unseen ones [57]. Popular strategies to address this problem include: increasing the diversity of training data via either ad-hoc augmentations (e.g. [37, 54]), adversarial learning (e.g. [55, 62]), or generative models (e.g. [40, 48]); explicitly learning domain-invariant representations [2], and sometimes decoupling the domain-specific and domain-independent components (e.g. [18,21,33]). Notably, the recent work of Gulrajani & Lopez-Paz [15] showed on a large testbed that learning a vanilla classifier on a pool of several datasets outperformed all modern techniques, thus sending a strong message on the importance of carefully designing the experimental protocol. Despite the shared goal of generalizing across domains and the constraint of not having access to the target distributions one fundamental difference of DG with the setup described herein is the lack of adaptability at test time. Instead, methods falling under the source-free domain adaptation paradigm [9] require no access to the training data during the process of adaptation. Liang et al. [29] assume to only have access to the source dataset's summary statistics, and relate the models fitting source and target domain by surmising that class centroids are only moderately shifted between the two datasets. Before adaptation, Kundu et al. [22, 23] consider a first “vendor-side” or “procurement” phase, during, which the target domain is not known and a model is trained on an artificially augmented training dataset which aims at mimicking possible domain shifts and category gaps that will be encountered downstream. Li et al. [27] propose the Collaborative Class Conditional GAN, which integrates the output of a prediction model into the loss of the generator to produce new samples in the style of the target domain, which in turns are used to adapt the model via backpropagation. In Test-time Training [51], Sun et al. enable effective test-time adaptation via self-supervision by jointly optimizing two branches (one supervised and one self-supervised) during training. While being vastly more practical than the original vanilla domain adaptation, the methods listed above are still quite limited in that they typically have an ad-hoc specific training procedure.

As mentioned in section 1, it would be desirable to facilitate model reuse, so that the progress made by the community in architecture design [12], self-supervised learning [8] or multi-modal learning [39] can be directly exploited.

The broad class of problem addressed herein has been referred to in the TENT paper [56] as the fully test-time adaptation scenario. In this case, the intent is to perform unsupervised test-time adaptation while “not restricting or altering model training”. In TENT, this is achieved with a simple entropy minimization loss, which informs the optimization of the channel-wise scale and bias parameters of batchnorm layers. As for normalization statistics, these are re-estimated on the test data, similarly to what is done in adaptive batchnorm (AdaBN) methods [28, 32, 45], which have shown strong performance on the perturbations of ImageNet-C [17]. In similar spirit, Liang et al. [30] updates the parameters of the feature extractor of a given model by maximizing a mutual information objective (SHOT-IM). SHOT, the final method proposed in the paper, is obtained by additionally considering a self-supervised pseudo-labelling term similar to Caron et al. [6] to mitigate potentially overconfident predictions.

Although motivated by similar considerations to TENT and SHOT, the approach described herein differs significantly in at least two aspects. First, given our model-independent desideratum, we empirically and explicitly study to which extent the described approach works across training strategies and architectures. This analysis is missing in prior works: as demonstrated below in section 6, the type of model being adapted is a variable that strongly affects the effectiveness of both TENT and SHOT. Second, for the sake of achieving high usability, the present techniques are particularly focused on online adaptation. As such, they leverage only limited data for adaptation, and, unlike prior works, give an important relevance to the non-i.i.d. scenario which arises in video streams.

### 3. Problem Formulation

The standard Unsupervised Domain Adaptation (UDA) problem considers a labelled source dataset sampled from a source distribution

$${𝒟}_{s} = \{ ( x , y ) ∼ {p}_{s} ( x , y ) \} ,$$

where x is an image and y∈Y its associated label from the set of source classes Y, together with an unlabelled target dataset sampled from an arbitrary target distribution

$${𝒟}_{t} = \{ x ∼ {p}_{t} ( x ) \} .$$

By imposing a covariate shift assumption [49], an invariant concept pₜ(y|x)=pₛ(y|x)=p(y|x) is supposed to exist between the two distributions. UDA then allows simultaneous access to both Ds and Dt in order to build a probabilistic parametric model q_{θ}(y|x) that adequately approximates the underlying concept p(y|x). In contrast, (fully) test-time adaptation [30, 56](TTA) disentangles adaptation from the training stage and does not have any knowledge of the latter, which is a part from the resulting trained model. As a model, we consider we are given a parametric classifier q_{θ}(y|x) trained on the source dataset alone, and that does not necessarily well approximate p(y|x) when evaluated at target samples. Therefore, the objective is to use Dₜ in an unsupervised fashion to correct and improve the model's performance on the target distribution.

The described embodiments address the online TTA problem, which implies that test samples from the target distribution are served as a stream of small batches, and that the model must adjust and predict at the same time. By virtue of being agnostic to the training stage, TTA makes it convenient to experiment with large models trained on large-scale datasets [24, 43, 60] potentially containing tens thousands of concepts. These datasets have been created with the purpose of covering a large portion of the concepts that may be of interest, and thus likely contain classes of a finer or equal (but not coarser) granularity than those required in specific TTA scenarios. To make the setting more practical, the standard assumption that the source classes [symbol] must exactly coincide with the target ones is relaxed. Instead, target classes may belong to a set of superclasses [symbol] , as long as there is a mapping

$$μ : y \to ℨ ⋃ \{ ⌀ \}$$

which maps each source class to either its unique corresponding superclass in the target domain if this exists, or to the null variable. Such experimental convenience does not fundamentally change the problem, and the output probabilities of the source model can be easily translated into target probabilities through

$${q}_{θ} ( z \vert x ) ∝ {\sum }_{y : μ ( y ) = z} {q}_{θ} ( y \vert x ) . \qquad ( 1 )$$

### 3.1. Scenarios of Interest

In online TTA, two orthogonal factors are considered that can occur in practical situations:

Distribution shift describes situations where pₛ(x)≠pₜ(x). Using Bayes' rule and the covariate shift assumption, one observes that such shift happens if and only if there exists some class z E Z such that

$${p}_{s} ( z ) {p}_{s} ( x \vert z ) \neq {p}_{t} ( z ) {p}_{t} ( x \vert z ) .$$

Two natural causes of such shifts arise from the previous equation: prior shift, in which pₜ(z) may differ from pₛ(z), and posterior shift, in which pₜ(x|z) may differ from pₛ(x|z).

Sampling shift: A standard modelling assumption is to consider that images are drawn i.i.d from the true target distribution pₜ(x, z). However, in most practical applications of online adaptation, such assumption breaks, as samples from real-world data streams (e.g., videos) can be highly correlated. Importantly, as shown in the next section, existing TTA methods fail dramatically to address such scenarios.

### 4. Silent Failure of Network Adaptation

In order to better approximate the underlying distribution p(z|x) at test-time, TTA methods usually propose to directly modify the parametric source model. We group such methods under the term Network Adaptation Methods (NAMs) methods. Specifically, such methods [30, 56] first partition the network into adaptable θ̅^{a} weights and frozen weights θ^{ƒ}, and proceed with an unsupervised loss minimization:

$${min}_{{θ}^{a}} {x ∼ {p}_{t} \{ x 〉}_{} ℒ ( x ; {θ}^{a} ⋃ {θ}^{f} ) \qquad ( 2 )$$

TTA methods mostly differ based on their choices of partition {θ^{ƒ}, θ^{a}} and loss function L. For instance, TENT [56] only adapts the scale and bias parameters (γ,β) of the batch normalization (BN) layers through entropy minimization, while SHOT [30] also adapts the convolutional filters of the model through mutual information maximization.

### On the Importance of Batch Diversity.

While NAMs indeed have the potential to correct the classifier and substantially improve the performances, they also have the ability to dramatically degrade it. Consecutive updates of the adaptable weights θ^{a} on narrow segments of the target distribution can cause the model to overspecialize and degenerate. Such behavior can be caused by the combination of a sub-optimal choice of hyper-parameters for a specific scenario and the lack of sample diversity at the batch level. Note that the latter is common in non-i.i.d. sampling, where the diversity of samples in each batch can be largely limited due to their correlation (e.g., consecutive frames in a video), but may also happen in i.i.d. scenarios with high class imbalance caused by a realistic prior shift.

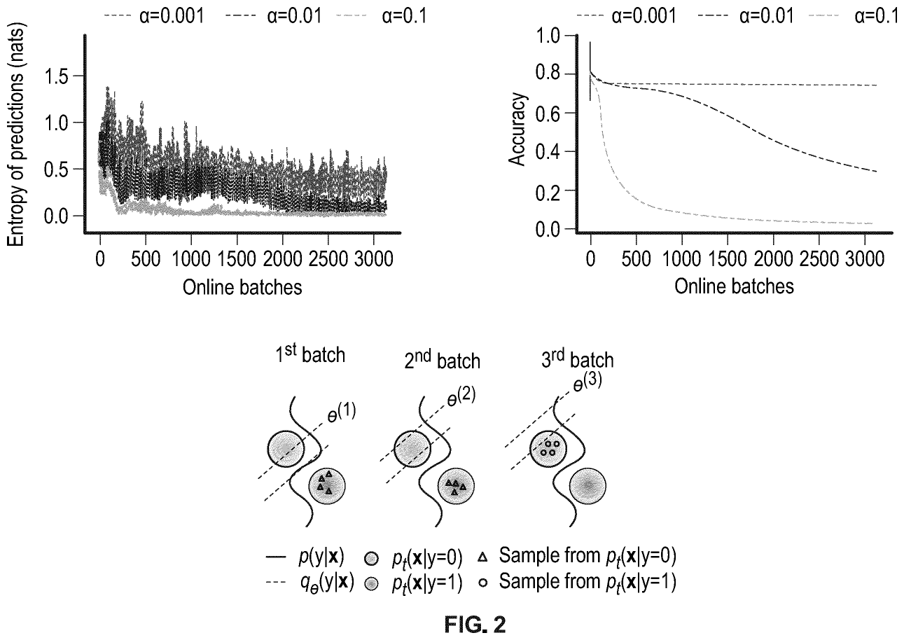

In FIG. 2, a failure mode of the widely used entropy minimization principle is demonstrated, in which the model receives a stream of batches that are highly homogenous, i.e., most samples in each batch share the same class. With a sub-optimal learning rate, Entropy Minimization degenerates the model silently, i.e., without exhibiting any distinctive behavior that would allow a clear diagnosis in the absence of labels.

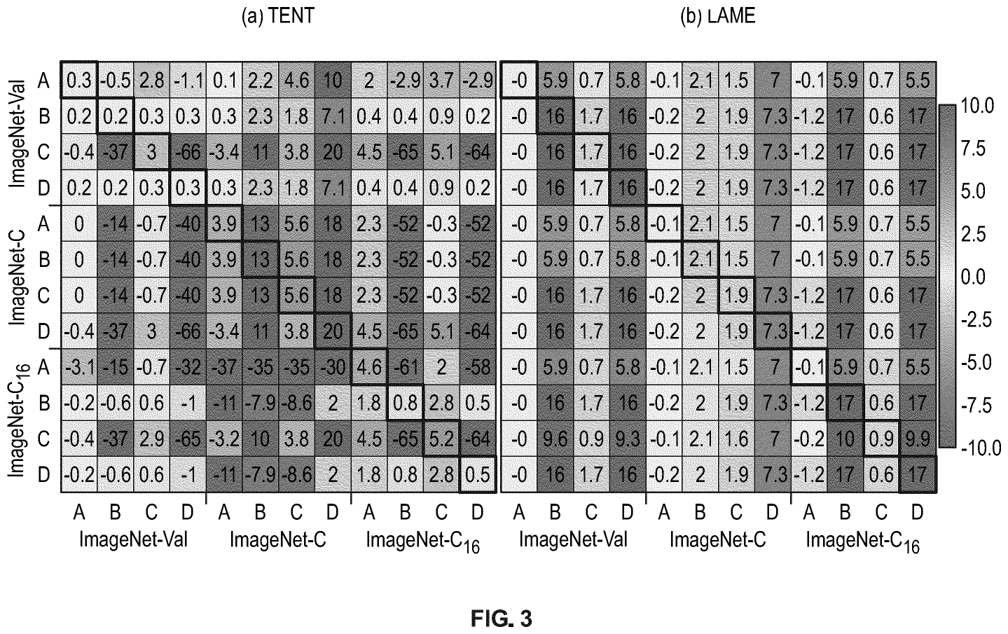

Properly choosing optimization hyper-parameters alleviates the problem, but does not solve it. It may be argued that optimally choosing hyper-parameters would solve this problem. However, tuning hyper-parameters for each target scenario would require access to labels, and thereby completely defeat the purpose of the whole TTA setting. Therefore, the former argument may only be valid if NAM's hyper-parameters effortlessly generalized across test-time scenarios. However, keeping entropy minimization as a running example, the left plot of FIG. 3 shows that such desideratum is practically not fulfilled. Precisely, we create a series of 12 validation scenarios, detailed in section 6, that provide a wide covering of the shifts discussed in subsection 3.1. For each shift, the optimal set of hyper-parameters is obtained and the method is then tested across all scenarios using this fixed configuration. The absolute improvement (or degradation) w.r.t the performance of the non-adapted model is reported. The clear trend emerging from FIG. 3 is that entropy minimization, used in TENT [56], is severely brittle w.r.t. hyperparameters configuration, especially in non i.i.d. and imbalanced scenarios where a suboptimal choice can degrade the non-adapted model's accuracy by up to 66%. In the end, the most viable strategy to avoid dramatic failure remains to choose highly conservative optimization hyper-parameters. While such strategy alleviates the identified issue, it also limits quite significantly the potential benefit of using NAMs at all, and therefore does not satisfactorily solve it.

FIG. 2 shows how adapting a network through entropy minimization in a non-i.i.d scenario is risky. The left plot monitors the entropy being minimized in an online, non-i.i.d setting on a real adaptation scenario. In parallel, the middle plot monitors the online accuracy, showing that for 2 out of 3 learning rates, the model silently collapses. The right figure depicts a toy 2D illustration of this problem, where observing too homogenous batches while enforcing high confidence through larger margins leads to the full degeneracy of an initially sound model.

FIG. 3 shows a cross-shift validation of hyperparameters for TENT [56] (left) and our proposed LAME method (right). Cell at position (i, j) shows the absolute improvement (or degradation) of the current method w.r.t to the baseline when using the optimal configuration for scenario i but evaluating the method in scenario j. Legend. A=i.i.d., B=non i.i.d., C=i.i.d.+prior shift, D=non i.i.d.+prior shift.

### 5. LAME Method

Instead of adopting an ambitious approach that may appear impractical down the road, the described embodiments address the problem upstream by designing an approach that is conservative in essence. Precisely, instead of modifying the parameters of the classifier, only a correction of its output probabilities is provided. On the downside, freezing the source classifier refrains our method from accumulating knowledge across batches. On the upside, it mitigates the intolerable risk of degenerating the classifier, reduces the compute requirements as it neither computes nor stores gradients, and inherently removes sensitive optimization hyperparameters, such as the learning rate or momentum, from the search.

Overall, we empirically demonstrate that such approach is largely more reliable and practical than NAMs.

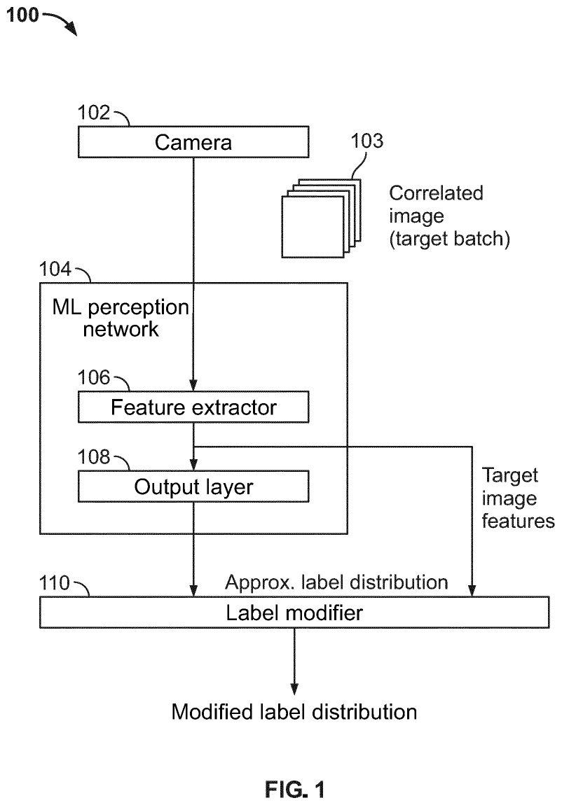

FIG. 1 shows highly schematic block diagram of an image processing system 100 operating with the Lame architecture. FIG. 1 considers a target batch of correlated images 103, captured from at least one camera 102, although as noted the techniques are applicable to other forms of perception input (such as lidar or radar point clouds).

An ML image classification network 104 is shown to comprise a feature extractor 106 (one or more feature extractor layers) and an output layer(s) 108. The feature extractor extracts a set of features from each target image 103, which is used by the output layer(s) 108 to probabilistically classify the image (or some part of the image). The probabilistic classification is captured in a distribution computed over possible labels returned at the output layer 108 (approximate label distribution).

A label modifier 110 receives the approximate label distribution, together with the set of features extracted from each target image. The label modifier 110 uses those two inputs to assign a modified label distribution to each target image 103. This is described in detail below, and involves the optimization of a loss function that penalizes divergence between the approximate label distribution and the modified label distribution for target image 103, whilst also penalizing deviation between the modified label distributions assigned to pairs of target images 103 having similar features.

### Formulation.

Assume we are given a batch of data sampled from the target distribution

$$x ∈ {N \times d}^{} ∼ {ρ}_{t}^{N} ( x ) ,$$

with N the number of samples and d the feature dimension. The method finds a latent assignment vector \tilde{z}ᵢ=( [symbol] ᵢₖ)_{1≤k≤K}∈Δ^{K-1} for each data point xᵢ, which aims to approximate the true distribution p(z|x), with K the number of classes and Δ^{K-1}={\tilde{z}∈[0,1]^{K}|1^{T}\tilde{z}=1} the probability simplex. A principled way to achieve this is to find assignments \tilde{Z} that maximize the log-likelihood of the data subject to simplex constraints \tilde{z}ᵢ∈Δ^{K-1}∀i:

$$ℒ ( \tilde{Z} ) = log ( {\prod }_{i = 1}^{N} {\prod }_{k = 1}^{K} {p ( {x}_{i} , k )}^{{\tilde{z}}_{i k}} ) {=}^{c} {\sum }_{i = 1}^{N} {\tilde{z}}_{i}^{T} log ( {p}_{i} ) \qquad ( 3 )$$

where \tilde{Z}∈{0,1}_{NK} is the vector that concatenates all assignment vectors

$${p}_{i} = {( p ( k \vert {x}_{i} ) )}_{1 \leq k \leq K} ∈ {[ 0 , 1 ]}^{K} ,$$

and c stands for equality up to an additive constant. Constrained problem (3) can be solved by replacing constraints z\tilde{ }ᵢ≥0 with convex negative-entropy penalties \tilde{z}ᵢ^{T} log(\tilde{z}ᵢ), each restricting the domain of z\tilde{ }ᵢ to non-negative values. This amounts to minimizing the following Kullback-Leibler (KL) divergences subject to 1^{T}\tilde{z}i=1∀i;

$${{\sum }_{i = 1}}^{N} {\tilde{z}}_{i}^{T} log ( {p}_{i} ) + {{\sum }_{i = 1}}^{N} {\tilde{z}}_{i}^{T} log ( {\tilde{z}}_{i} ) = {{\sum }_{i = 1}}^{N} KL ( {\tilde{z}}_{i} ‖ {p}_{i} ) \qquad ( 4 )$$

Problem (4) is minimized for z\tilde{ }ᵢ=pᵢ, ∀i. The problem in Eq. (4) is that we don't have access to pᵢ, but only to parametric source model q_{θ,i}=(q_{θ}(k|xᵢ))_{1≤k≤K} which, recall, might be a poor approximation of the true distribution when evaluated on target samples x˜pₜ(x). In fact, naively replacing pᵢ by q_{θ,i} in Eq. (4) simply recovers the predictions from the source model zᵢ=q_{θ,i}.

An elegant and simple solution is to compensate for the errors in this approximation by encouraging desirable and general properties on the solution. The Manifold smoothness assumption [1] offers a principled way to leverage unlabelled data by encouraging smooth assignments. In the present example, Laplacian regularization is used, which encourages neighbours in the feature space to have consistent latent assignments. Laplacian regularization is widely used in semi-supervised learning [1, 7, 19], where it is optimized jointly with supervised losses over labelled data points, or in graph clustering [46, 47, 53], where it is optimized subject to class-balance constraints. The present TTA problem is different as, unlike semi-supervised learning, there is no additional supervision and, unlike clustering, class-balance constraints are irrelevant (or even detrimental).

Hence, a “Laplacian Adjusted Maximum-likelihood Estimation” (LAME) is introduced, which minimizes the likelihood in (4) jointly with a Laplacian correction, subject to constraints 1^{T}\tilde{z}ᵢ=1, ∀i:

$${ℒ}^{LAME} ( \tilde{Z} ) = {\sum }_{i} KL ( {\tilde{z}}_{i} ‖ {p}_{i} ) - {\sum }_{i , j} {w}_{i j} {\tilde{z}}_{i}^{T} {\tilde{z}}_{j} \qquad ( 5 )$$

where wᵢⱼ=w(ϕ(xᵢ), ϕ(xⱼ)), with ϕ denoting a pretrained feature extractor (e.g., the penultimate layer of the model) and w is a function measuring affinity between points i and j. The closer the points in the feature space, the higher their affinity. Clearly, when the affinity is high (i.e., wᵢⱼ is large), minimizing the Laplacian term in (5) seeks the largest possible value of dot product \tilde{z}ᵢ^{T}\tilde{z}ⱼ, thereby assigning points i and j to the same class. Therefore, the model in (5) could be viewed as a graph clustering of the batch data, regularized by a KL penalty discouraging substantial deviations from the source-model predictions.

### Efficient Optimization Via a Concave-Convex Procedure.

In the following, a highly efficient concave-convex procedure is derived for minimizing the model in (5), which yields decoupled updates of assignments variables z\tilde{ }ᵢ, and scales linearly in both N and K, with convergence guarantee. Concave-Convex Procedures (CCCP) [61] are instances of the general Majorize-Minimize (MM) principle for optimization [25]. At each iteration n, and given a current solution Z\tilde{ } (n), MM algorithms update the optimization variable as the minimum of an upper bound on the objective, which is tight at the current solution. This guarantees that the objective does not increase at each iteration. For the sum of a concave and a convex function, as is the case of the objective in (5), a CCCP replaces the concave part by its linear first-order approximation at the current solution, which is a tight upper bound, while keeping the convex part unchanged. In the present case, the Laplacian term is concave when affinity matrix W=[w_{i,j}] is positive semi-definite, while the KL term is convex. The concavity of the Laplacian for positive semi-definite W could be verified by re-writing the term as follows:

$$- {\sum }_{i , j} {w}_{ij} {\tilde{z}}_{i}^{T} {\tilde{z}}_{j} = - \tilde{Z} ( W ⊗ I ) \tilde{Z} ,$$

where ⊗ denotes the Kronecker product and I is the N-by-N identity matrix (when W is positive semi-definite, W⊗I is also positive semi-definite). Thus, in the present case, the Laplacian term in (5) is replaced by

−((W⊗I)\tilde{Z}⁽ⁿ⁾)^{T}\tilde{Z},

which yields the following tight upper bound, up to an additive constant independent of Z\tilde{ }:

$${ℒ}^{L A M E} ( \tilde{Z} ) {\leq }^{c} {\sum }_{i} KL ( {\tilde{z}}_{i} ‖ {p}_{i} ) - {( ( W ⊗ I ) {\tilde{Z}}^{( n )} )}^{T} \tilde{Z} \qquad ( 6 )$$

Solving the Karush-Kuhn-Tucker (KKT) conditions corresponding to minimizing convex upper bound (6), subject to constraints 1^{T}\tilde{z}ᵢ=1, ∀i, yields the following decoupled updates of the assignment variables at each iteration n

$${\tilde{z}}_{ik}^{( n + 1 )} = \frac{{p}_{s} ( k \vert {x}_{i} ) exp ( - {\sum }_{j} {w}_{ij} {\tilde{z}}_{jk}^{( n )} )}{{\sum }_{{k}^{′}} {p}_{s} ( {k}^{′} \vert {x}_{i} ) exp ( - {\sum }_{j} {w}_{ij} {\tilde{z}}_{{jk}^{′}}^{( n )} )} \qquad ( 7 )$$

### 6. Experiments

Our experimental protocol is mainly guided by the desire to assess both model and domain independence of TTA methods. For model independence, we need to evaluate the performance of methods under a variety of pre-trained models. As for domain independence, a single fixed trained model must allow to evaluate a TTA method under multiple adaptation scenarios. This implies that the source classes encoded in the pre-trained model must be both granular and numerous enough to be easily mapped to multiple downstream datasets.

### Networks.

Following the above mentioned requirements, and owing to the multiplicity of publicly available models as well as the large number of classes covered by ImageNet [44] trained—or finetuned—models therefore represent an ideal ground for our experiments. In particular, they allow to evaluate model independence along two axis. First, with respect to the training procedure by experimenting with the same ResnNet-50 [16] architecture (abbreviated RN in the following), but trained in three different ways: using the original release from MSRA [16], using Torchvision's [34] and finally using the self-supervised SimCLR [8]. Second, with respect to the architecture itself, by providing results on 5 different backbones, including the RN-18, RN-50, RN-101, the EfficientNet EN-B4 [52] and the recent Vision Transformer ViT-B [13].

### Evaluation Protocol.

With the design choice of using ImageNet pre-trained models fixed, we consider a total of 7 target datasets that can all be mapped to ImageNet-classes, 3 of which are kept for validation purposes, and the other 4 for testing scenarios. Starting from the motivation that hyper-parameters should be fixed prior to testing, we formulate an exhaustive validation procedure that allows to obtain the set of hyper-parameters that is most susceptible to generalize across unseen domains, while not leaking any information about final testing scenarios. Specifically, we create a total of 12 validation scenarios and 7 testing scenarios that both provide a wide covering of the shifts of interest described in subsection 3.1. Below, we describe in more details how those scenarios are generated.

For the validation stage, we consider 3 datasets. First, we use the original validation set of ImageNet [44]. To devise posterior shift, we consider ImageNet-C-Val which augments the original images with 9 real-life perturbations—the other 10 from the original ImageNet-C [17] are left for testing—with varying intensity. Finally we consider ImageNet-C16, a variant of ImageNet-C that simulates an easier but practical downstream scenario where only 32 ImageNet classes are mapped to 16 semantic superclasses. By reducing the total number of classes, ImageNet-C16 also reduces class diversity at the batch level, which we identified as a critical factor for NAMs in Section 4, and is therefore datasets, 2 prior shifts (with and without Zipf) and 2 sampling schemes (i.i.d. or non i.i.d.) adds up to the 12 validation scenarios announced earlier. Each validation experiment is repeated 3 times with random seeds.

As for testing, we design 4 i.i.d. and 3 non i.i.d. test scenarios. For the i.i.d. cases, we use the 4 combinations yielded by coupling ImageNet-C-Test and ImageNetV2 [41] with presence/absence of Zipf class-imbalance. As for the 3 non i.i.d. scenarios, we reuse ImageNet-V2, along with two video datasets ImageNet-Vid [44] and TAOLaSOT [11]. Keeping the idea of feeding the model with a sequence of tasks, the video datasets allow us to form realistic tasks by simply grouping frames from the same video together. Note that some datasets listed above require the use of a mapping, as described in the problem formulation section 3. We use 10 random runs for each test experiment.

### Methods.

As a first baseline, we evaluate the source-trained model without any adaptation, referred to as Baseline. For Network Adaptation Methods (NAMs), we reproduce and evaluate four state-of-the-art methods that can be run in an online fashion: TENT [56] based on entropy minimization, SHOT-IM based on mutual information maximization, PseudoLabel [26] based on min-entropy minimization and AdaBN [28] based on batch normalization statistics alignment. Finally, we evaluate our formulated LAME method.

### Hyper-Parameters.

For all NAMs, we define a common grid-search spanning salient optimization hyperparameters, including learning rate, optimization momentum, batch normalization momentum and the partition of adaptable vs non-adaptable parameters {θ^{ƒ}, θ^{a}}. As for LAME, its very design largely restricts the space of hyperparameters, and we only search over the k in the k-NN affinity used to describe w, following [64].

### 6.1. Results

LAME steps towards domain-independence. As motivated in Section 4, most scenario-sensitive hyperparameters come from the optimization of the network, rather than the methods themselves. By virtue of completely freezing the classifier, our LAME approach simply frees itself from such hyper-parameters. LAME only tries to find optimal shallow assignments through a simple bound-optimization procedure that itself does not introduce any hyper-parameters. At that point, we are only left with hyper-parameters induced by the choice of the affinity matrix, which we empirically demonstrate generalizes substantially better. This claim is first supported by inspecting the LAME's cross-shift validation matrix, used in Section 4 to illustrate NAMs' brittleness. The result is provided on the right plot of FIG. 3, and shows drastic improvement in both average performance and worst-case degradation across all cases, w.r.t. TENT's validation matrix and other NAMs.

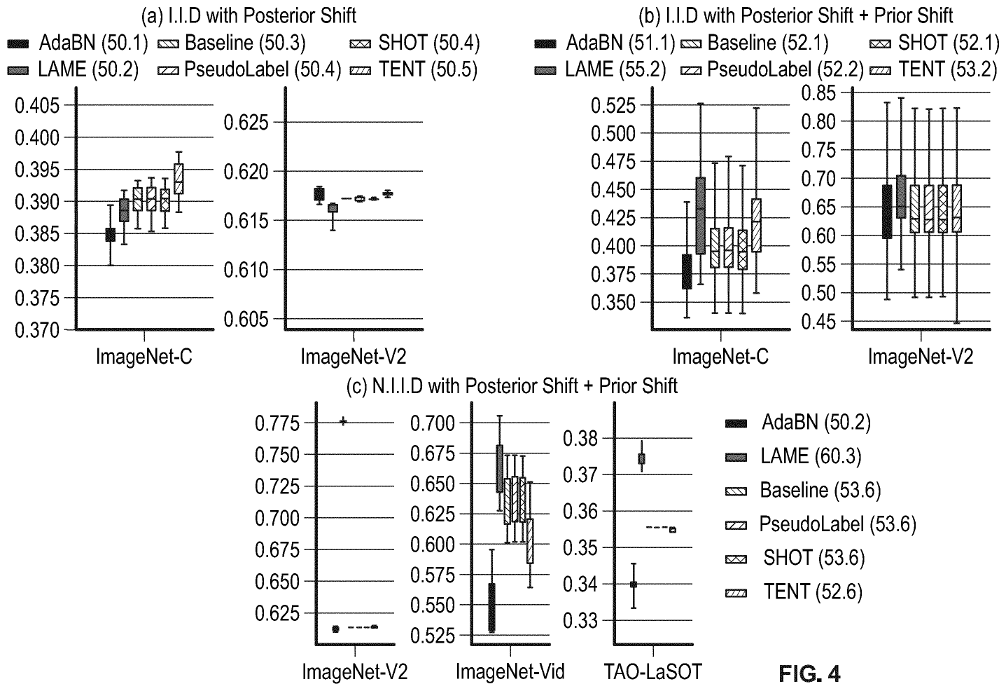

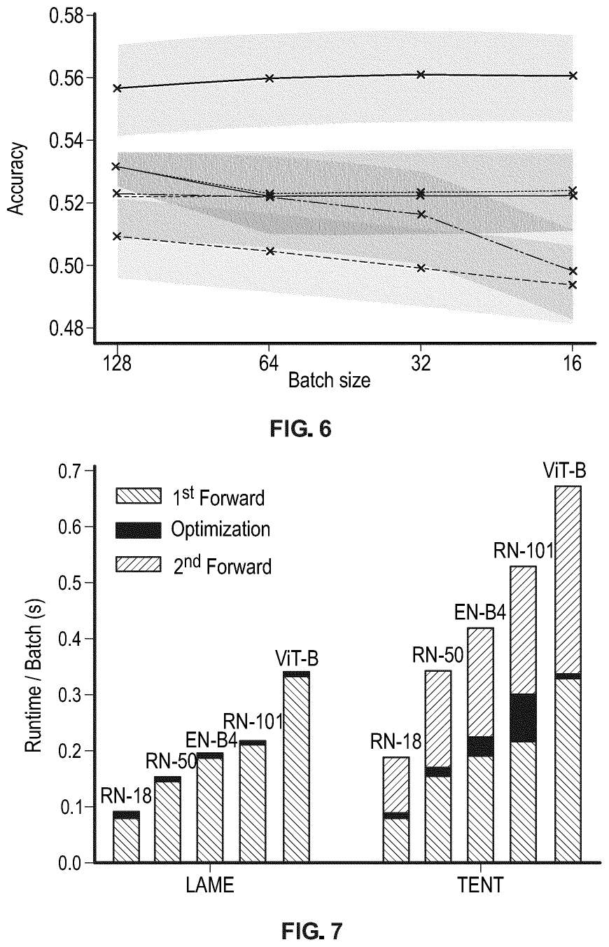

A second empirical evidence supporting this claim comes from the results on the test scenarios, shown in FIG. 4, where LAME never fares more than 0.5% below the baseline, while bringing up to 15% boost on non i.i.d. scenarios. Note that such improvement comes almost independently of the batch size used, as shown in FIG. 6, where LAME conserves a close to 4% average improvement over the baseline.

Changes in the training stage surprinsingly break NAMs. In regard of model-independence, we first inspect whether methods are robust to changes in the training procedure. Such robustness is desired e.g. in cases where the source model provider needs to update the model, in which case we would expect our method to continue working similarly without requiring a new round of validation. As a first simple scenario, we observe whether the set of hyperparameters obtained through validation with the Original RN-50 generalize to the RN-50 provided in TorchVision.

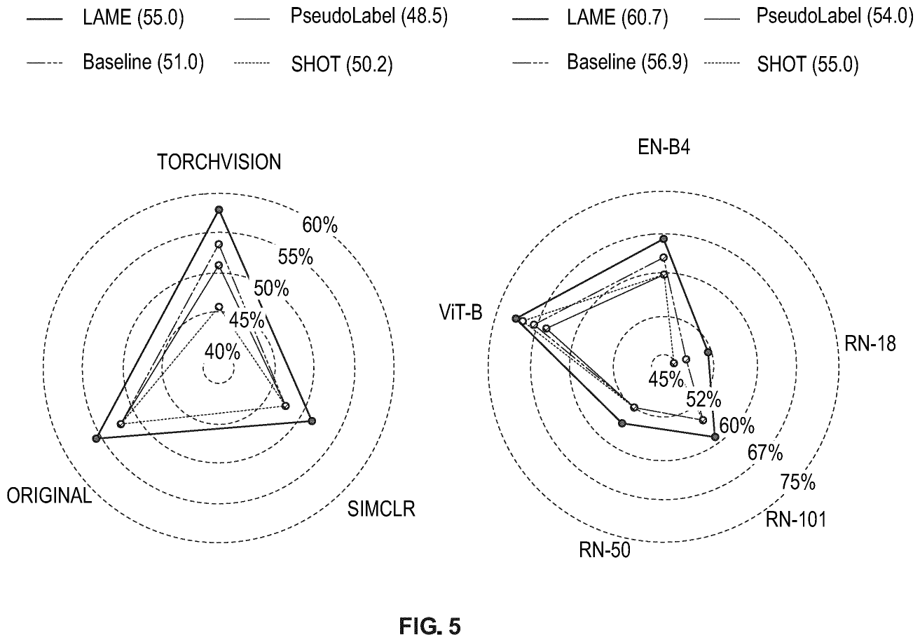

Given that both models were trained with standard supervision and minor experimental differences, one can reasonably expect the methods to perform roughly similarly using the same set of hyper-parameters. Results on the left chart of FIG. 5 suggest quite the opposite. While our LAME conserves the same relative improvement w.r.t. baseline, all NAMs loose significant ground, with more than 10% drop average accuracy across the 7 test target scenarios for PseudoLabel. We further experiment with a RN-50 trained using the self-supervised SimCLR method, and observe that LAME once again retains its relative improvement of 4%, with no other method beating the baseline. LAME generalizes across architectures, NAMs don't. Another desirable property of methods lies in their ability to generalize to different architectures. Particularly, exhaustive validation over very large models can become prohibitively expensive and makes easy plug-and-play a particularly attractive feature. Results with four architectures ranging from the small RN-18 to the larger ViT-B transformer are shown in the right chart of FIG. 5. Across the board, LAME is the only method able to retain a consistently significant improvement w.r.t. the baseline, which itself remains a better option than all NAMs, especially with small backbones such as the RN-18.

LAME runs twice as fast and requires twice less memory than NAMs. Provided that several direct applications of test-time adaptation involve real-time adaptation to data streams, the ability to run as efficiently as possible can also be a major factor for practitioners. Runtimes are divided into 3 stages: 1st forward, optimization—corresponding to the backpropagation for network adaptation methods and to the bound-optimization for LAME—, and 2nd forward—only needed for methods that modify the weights of the model—. Altogether, these three contributions account for the total runtime of each method. Results provided in FIG. 6 places LAME testifies of the clear advantage LAME has NAMs, with negligible overhead w.r.t. the simple baseline. In terms of memory requirements, LAME does not require to keep any gradients or intermediary buffers in the model, which roughly divides GPU memory requirement by 2 w.r.t. NAMs.

FIG. 4 shows results across the 7 testing scenarios, using the same Original RN-50 that was used for validation. The central white dot represents the mean achieved for each scenario. The batch size used is 64. Each experiment is run 10 times with different random seeds.

FIG. 5: transferability of hyper-parameters across models. (Left): Across different training procedures, but using the exact same RN-50 architecture. (Right): Across different architectures ranging from a RN-18 to recent vision transformer ViT-B.

FIG. 6: average accuracy across 7 test scenarios versus batch size, using the Original RN-50. Above 128, NAMs don't fit on a standard 11 GB GPU. In fact, for larger architectures such as ViT-B, a batch size of 16 is already enough to max out memory. Therefore, performing well in the low batch-size regime is a highly desirable property for TTA methods.

FIG. 7. Runtime per batch of the different methods for 5 different backbones: RN-18, RN-50, EN-B4, RN-101 and ViT-B. Batch 64 is used for the RN—* family, and 16 for EN-B4 and ViT-B (as both use 380×380 images instead of 224×224). LAME provides corrected outputs without requiring a second forward pass through the network.

### 7. Conclusion

Herein is provided a lightweight Laplacian-based correction of model outputs for online adaptation to shifted test-time distributions that exhibits promising performances over a wide range of scenarios. While the method never significantly degrades the baseline results—as opposed to all adaptation methods compared against-, it also does not noticeably help in standard i.i.d balanced scenarios. Indeed, Laplacian regularization essentially performs label propagation, which can reasonably be expected to help in scenarios in which batches contain at least some samples from the same class (typically non i.i.d scenarios or class-imbalanced scenarios). Notice that such scenarios are those where standard adaptation methods can dramatically fail. Therefore, hybrid adaptation-correction methods have the potential to effectively tackle a wider variety of scenarios.

A perception component may comprise one or more trained perception models for perceiving physical structure. For example, machine vision processing is frequently implemented using convolutional neural networks (CNNs). Such networks are typically trained on large numbers of training images which have been annotated with information that the neural network is required to learn (a form of supervised learning). At training time, the network is presented with thousands, or preferably hundreds of thousands, of such annotated images and learns for itself how features captured in the images themselves relate to annotations associated therewith. This is a form of visual structure detection applied to images. Each image is annotated in the sense of being associated with annotation data. The image serves as a perception input, and the associated annotation data provides a “ground truth” for the image. Perception components can also be applied to other perception modalities, such as lidar or radar inputs, or a combination of different perception modalities (e.g. two or more of image, lidar and radar). Such inputs may be captured using one or more perception sensors (e.g. image capture device(s), radar/lidar unit(s) etc.). Training and analysis of such components can also be performed using “synthetic” inputs, computed using one or more sensor models. Note all description herein relating to “real” inputs applies equally to synthetic inputs designed to approximate real inputs and which exhibit similar statistical properties (e.g. as generated using sensor model(s), such as camera, lidar or radar models, 3D modelling, possibly with techniques such as path tracking and the like to generate synthetic inputs). Sensor data may be real or synthetic unless otherwise indicated. As well as images, CNNs and other forms of perception models/components can be architected to receive and process other forms of perception inputs, such as point clouds, voxel tensors, surface meshes etc., and to perceive structure in both 2D and 3D space. In the context of training generally, a perception input may be referred to as a “training example” or “training input”. By contrast, training examples captured for processing by a trained perception component at runtime may be referred to as “runtime inputs”. Annotation data associated with a training input provides a ground truth for that training input in that the annotation data encodes an intended perception output for that training input. In a supervised training process, parameters of a perception component are tuned systematically to minimize, to a defined extent, an overall measure of difference between the perception outputs generated by the perception component when applied to the training examples in a training set (the “actual” perception outputs) and the corresponding ground truths provided by the associated annotation data (the intended perception outputs). In this manner, the perception input “learns” from the training examples, and moreover is able to “generalize” that learning, in the sense of being able, once trained, to provide meaningful perception outputs for perception inputs it has not encountered during training.

Such perception components are a cornerstone of many established and emerging technologies. For example, in the field of robotics, mobile robotic systems that can autonomously plan their paths in complex environments are becoming increasingly prevalent. An example of such a rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. In order for an AV to plan safely, it is crucial that it is able to observe its environment accurately and reliably. This includes the need for accurate and reliable detection of real-world structure in the vicinity of the vehicle. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

References herein to components, functions, modules and the like, denote functional components of a computer system, such as the image processing system 100 of FIG. 1, which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

### REFERENCES

Each of the following is incorporated herein by reference in its entirety.
[1] Mikhail Belkin, Partha Niyogi, and Vikas Sindhwani. Manifold regularization: A geometric framework for learning from labeled and unlabeled examples. Journal of machine learning research, 7(11), 2006.
[2] Shai Ben-David, John Blitzer, Koby Crammer, Fernando Pereira, et al. Analysis of representations for domain adaptation. Advances in neural information processing systems, 2007.
[3] Rishi Bommasani, Drew A Hudson, Ehsan Adeli, Russ Altman, Simran Arora, Sydney von Arx, Michael S Bernstein, Jeannette Bohg, Antoine Bosselut, Emma Brunskill, et al. On the opportunities and risks of foundation models. arXiv preprint arXiv:2108.07258, 2021.
[4] Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.
[5] Collin Burns and Jacob Steinhardt. Limitations of post-hoc feature alignment for robustness. In CVPR, 2021.
[6] Mathilde Caron, Piotr Bojanowski, Armand Joulin, and Matthijs Douze. Deep clustering for unsupervised learning of visual features. In ECCV, 2018.
[7] Olivier Chapelle, Bernhard Schlkopf, and Alexander Zien. Semi-Supervised Learning. The MIT Press, 1st edition, 2010.
[8] Ting Chen, Simon Kornblith, Mohammad Norouzi, and Geoffrey Hinton. A simple framework for contrastive learning of visual representations. In ICML, pages 1597-1607. PMLR, 2020.
[9] Boris Chidlovskii, Stephane Clinchant, and Gabriela Csurka. Domain adaptation in the absence of source domain data. In Proceedings of the 22nd ACM SIGKDD International Conference on Knowledge Discovery and Data Mining, 2016.
[10] Gabriela Csurka. Domain adaptation for visual applications: A comprehensive survey. arXiv preprint arXiv:1702.05374, 2017.
[11] Achal Dave, Tarasha Khurana, Pavel Tokmakov, Cordelia Schmid, and Deva Ramanan. Tao: A large-scale benchmark for tracking any object. In ECCV, pages 436-454. Springer, 2020.
[12] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. In ICLR, 2021.
[13] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al. An image is worth 16×16 words: Transformers for image recognition at scale. ICLR, 2021.
[14] Yaroslav Ganin and Victor Lempitsky. Unsupervised domain adaptation by backpropagation. In ICML. PMLR, 2015.
[15] Ishaan Gulrajani and David Lopez-Paz. In search of lost domain generalization. In ICLR, 2021.
[16] Kaiming He, Xiangyu Zhang, Shaoqing Ren, and Jian Sun. Deep residual learning for image recognition. In CVPR, pages 770-778, 2016.
[17] Dan Hendrycks and Thomas Dietterich. Benchmarking neural network robustness to common corruptions and perturbations. ICLR, 2019.
[18] Maximilian Ilse, Jakub M Tomczak, Christos Louizos, and Max Welling. Diva: Domain invariant variational autoencoders. In Medical Imaging with Deep Learning. PMLR, 2020.
[19] Ahmet Iscen, Giorgos Tolias, Yannis Avrithis, and Ondrej Chum. Label propagation for deep semi-supervised learning. In CVPR, 2019.
[20] Guoliang Kang, Lu Jiang, Yi Yang, and Alexander G Hauptmann. Contrastive adaptation network for unsupervised domain adaptation. In CVPR, 2019.
[21] Aditya Khosla, Tinghui Zhou, Tomasz Malisiewicz, Alexei A Efros, and Antonio Torralba. Undoing the damage of dataset bias. In ECCV, 2012.
[22] Jogendra Nath Kundu, Naveen Venkat, R Venkatesh Babu, et al. Universal source-free domain adaptation. In CVPR, 2020.
[23] Jogendra Nath Kundu, Naveen Venkat, Ambareesh Revanur, R Venkatesh Babu, et al. Towards inheritable models for open-set domain adaptation. In CVPR, 2020.
[24] Alina Kuznetsova, Hassan Rom, Neil Alldrin, Jasper Uijlings, Ivan Krasin, Jordi Pont-Tuset, Shahab Kamali, Stefan Popov, Matteo Malloci, Alexander Kolesnikov, Tom Duerig, and Vittorio Ferrari. The open images dataset v4: Unified image classification, object detection, and visual relationship detection at scale. IJCV, 2020.
[25] Kenneth Lange, David R Hunter, and Ilsoon Yang. Optimization transfer using surrogate objective functions. Journal of computational and graphical statistics, 9(1):1-20, 2000.
[26] Dong-Hyun Lee et al. Pseudo-label: The simple and efficient semi-supervised learning method for deep neural networks. In Workshop on challenges in representation learning, ICML, volume 3, page 896, 2013.
[27] Rui Li, Qianfen Jiao, Wenming Cao, Hau-San Wong, and Si Wu. Model adaptation: Unsupervised domain adaptation without source data. In CVPR, 2020.
[28] Yanghao Li, Naiyan Wang, Jianping Shi, Xiaodi Hou, and Jiaying Liu. Adaptive batch normalization for practical domain adaptation. Pattern Recognition, 80, 2018.
[29] Jian Liang, Ran He, Zhenan Sun, and Tieniu Tan. Distant supervised centroid shift: A simple and efficient approach to visual domain adaptation. In CVPR, 2019.
[30] Jian Liang, Dapeng Hu, and Jiashi Feng. Do we really need to access the source data? source hypothesis transfer for unsupervised domain adaptation. In ICML, pages 6028-6039. PMLR, 2020.
[31] Mingsheng Long, Yue Cao, Jianmin Wang, and Michael Jordan. Learning transferable features with deep adaptation networks. In International conference on machine learning, pages 97-105. PMLR, 2015.
[32] Zachary Nado, Shreyas Padhy, D Sculley, Alexander D'Amour, Balaji Lakshminarayanan, and Jasper Snoek. Evaluating prediction-time batch normalization for robustness under covariate shift. arXiv preprint arXiv:2006.10963, 2020.
[33] Li Niu, Wen Li, and Dong Xu. Multi-view domain generalization for visual recognition. In CVPR, 2015.
[34] Adam Paszke, Sam Gross, Francisco Massa, Adam Lerer, James Bradbury, Gregory Chanan, Trevor Killeen, Zeming Lin, Natalia Gimelshein, Luca Antiga, Alban Desmaison, Andreas Kopf, Edward Yang, Zachary DeVito, Martin Raison, Alykhan Tejani, Sasank Chilamkurthy, Benoit Steiner, Lu Fang, Junjie Bai, and Soumith Chintala. Pytorch: An imperative style, high-performance deep learning library. pages 8024-8035, 2019.
[35] Vishal M Patel, Raghuraman Gopalan, Ruonan Li, and Rama Chellappa. Visual domain adaptation: A survey of recent advances. IEEE signal processing magazine, 2015.
[36] David Patterson, Joseph Gonzalez, Quoc Le, Chen Liang, Lluis-Miquel Munguia, Daniel Rothchild, David So, Maud Texier, and Jeff Dean. Carbon emissions and large neural network training. arXiv preprint arXiv:2104.10350, 2021.
[37] Aayush Prakash, Shaad Boochoon, Mark Brophy, David Acuna, Eric Cameracci, Gavriel State, Omer Shapira, and Stan Birchfield. Structured domain randomization: Bridging the reality gap by context-aware synthetic data. In International Conference on Robotics and Automation (ICRA). IEEE, 2019.
[38] Sanjay Purushotham, Wilka Carvalho, Tanachat Nilanon, and Yan Liu. Variational recurrent adversarial deep domain adaptation. In ICLR, 2016.
[39] Alec Radford, Jong Wook Kim, Chris Hallacy, Aditya Ramesh, Gabriel Goh, Sandhini Agarwal, Girish Sastry, Amanda Askell, Pamela Mishkin, Jack Clark, et al. Learning transferable visual models from natural language supervision. arXiv preprint arXiv:2103.00020, 2021.
[40] Mohammad Mahfujur Rahman, Clinton Fookes, Mahsa Baktashmotlagh, and Sridha Sridharan. Multi-component image translation for deep domain generalization. In 2019 IEEE Winter Conference on Applications of Computer Vision (WACV), 2019.
[41] Benjamin Recht, Rebecca Roelofs, Ludwig Schmidt, and Vaishaal Shankar. Do imagenet classifiers generalize to imagenet? In ICML, pages 5389-5400. PMLR, 2019.
[42] William J Reed. The pareto, zipf and other power laws. Economics letters, 74(1):15-19, 2001.
[43] Tal Ridnik, Emanuel Ben-Baruch, Asaf Noy, and Lihi Zelnik-Manor. Imagenet-21k pretraining for the masses. In NeurIPS, 2021.
[44] OLGA RUSSAKOVSKY, JIA DENG, HAO SU, JONATHAN KRAUSE, SANJEEV SATHEESH, SEAN MA, ZHIHENG HUANG, ANDREJ KARPATHY, ADITYA KHOSLA, MICHAEL BERNSTEIN, ALEXANDER C. BERG, AND LI FEI-FEI. IMAGENET LARGE SCALE VISUAL RECOGNITION CHALLENGE. INTERNATIONAL JOURNAL OF COMPUTER VISION (IJCV), 115(3):211-252, 2015.
[45] STEFFEN SCHNEIDER, EVGENIA RUSAK, LUISA ECK, OLIVER BRINGMANN, WIELAND BRENDEL, AND MATTHIAS BETHGE. IMPROVING ROBUSTNESS AGAINST COMMON CORRUPTIONS BY COVARIATE SHIFT ADAPTATION. NEURIPS, 2020.
[46] URI SHAHAM, KELLY STANTON, HENRY LI, RONEN BASRI, BOAZ NADLER, AND YUVAL KLUGER. SPECTRALNET: SPECTRAL CLUSTERING USING DEEP NEURAL NETWORKS. IN ICLR, 2018.
[47] JIANBO SHI AND JITENDRA MALIK. NORMALIZED CUTS AND IMAGE SEGMENTATION. PAMI, 22(8):888-905, 2000.
[48] NATHAN SOMAVARAPU, CHIH-YAO MA, AND ZSOLT KIRA. FRUSTRATINGLY SIMPLE DOMAIN GENERALIZATION VIA IMAGE STYLIZATION. ARXIV PREPRINT ARXIV:2006.11207, 2020.
[49] AMOS STORKEY. WHEN TRAINING AND TEST SETS ARE DIFFERENT: CHARACTERIZING LEARNING TRANSFER. DATASET SHIFT IN MACHINE LEARNING, 30:3-28, 2009.
[50] BAOCHEN SUN AND KATE SAENKO. DEEP CORAL: CORRELATION ALIGNMENT FOR DEEP DOMAIN ADAPTATION. ARXIV PREPRINT ARXIV:1607.01719, 2016.
[51] YU SUN, XIAOLONG WANG, ZHUANG LIU, JOHN MILLER, ALEXEI EFROS, AND MORITZ HARDT. TEST-TIME TRAINING WITH SELF-SUPERVISION FOR GENERALIZATION UNDER DISTRIBUTION SHIFTS. IN ICML. PMLR, 2020.
[52] MINGXING TAN AND QUOC LE. EFFICIENTNET: RETHINKING MODEL SCALING FOR CONVOLUTIONAL NEURAL NETWORKS. IN ICML, PAGES 6105-6114. PMLR, 2019.
[53] MENG TANG, DMITRII MARIN, ISMAIL BEN AYED, AND YURI BOYKOV. KERNEL CUTS: KERNEL AND SPECTRAL CLUSTERING MEET REGULARIZATION. IJCV, 127:477-511, 2019.
[54] JOSH TOBIN, RACHEL FONG, ALEX RAY, JONAS SCHNEIDER, WOJCIECH ZAREMBA, AND PIETER ABBEEL. DOMAIN RANDOMIZATION FOR TRANSFERRING DEEP NEURAL NETWORKS FROM SIMULATION TO THE REAL WORLD. IN IEEE/RSJ INTERNATIONAL CONFERENCE ON INTELLIGENT ROBOTS AND SYSTEMS (IROS). IEEE, 2017.
[55] Riccardo Volpi, Hongseok Namkoong, Ozan Sener, John Duchi, Vittorio Murino, and Silvio Savarese. Generalizing to unseen domains via adversarial data augmentation. In NeurIPS, 2018.
[56] Dequan Wang, Evan Shelhamer, Shaoteng Liu, Bruno Olshausen, and Trevor Darrell. Tent: Fully test-time adaptation by entropy minimization. ICLR, 2021.
[57] Jindong Wang, Cuiling Lan, Chang Liu, Yidong Ouyang, Wenjun Zeng, and Tao Qin. Generalizing to unseen domains: A survey on domain generalization. arXiv preprint arXiv:2103.03097, 2021.
[58] Mei Wang and Weihong Deng. Deep visual domain adaptation: A survey. Neurocomputing, 2018.
[59] Garrett Wilson and Diane J Cook. A survey of unsupervised deep domain adaptation. ACM Transactions on Intelligent Systems and Technology (TIST), 2020.
[60] Baoyuan Wu, Weidong Chen, Yanbo Fan, Yong Zhang, Jinlong Hou, Jie Liu, and Tong Zhang. Tencent ml-images: A large-scale multi-label image database for visual representation learning. IEEE Access, 7:172683-172693, 2019.
[61] Alan L. Yuille and Anand Rangarajan. The concave-convex procedure (CCCP). In NeurIPS, 2001.
[62] Kaiyang Zhou, Yongxin Yang, Timothy Hospedales, and Tao Xiang. Deep domain-adversarial image generation for domain generalisation. In AAAI, 2020.
[63] Xiaojin Zhu, Zoubin Ghahramani, and John D Lafferty. Semi-supervised learning using gaussian fields and harmonic functions. In Proceedings of the 20th International conference on Machine learning (ICML-03), pages 912-919, 2003.
[64] Imtiaz Ziko, Jose Dolz, Eric Granger, and Ismail Ben Ayed. Laplacian regularized few-shot learning. In ICML, pages 11660-11670. PMLR, 2020.

1. A computer-implemented method of classifying perception inputs of a target batch, the method comprising:
in a label approximation phase, computing an approximate label distribution for each perception input in a plurality of perception inputs of the target batch using a trained machine learning (ML) perception component, each perception input having parameters learned from training on a source training set, the approximate label distribution exhibiting error caused by a domain shift between the source training set and the target batch;
in an online label optimization phase, assigning a modified label distribution to each input of the target batch, via optimization of an unsupervised loss function, the unsupervised loss function comprising:
(i) a first term that penalizes divergence between the approximate label distribution and the modified label distribution for each input of the target batch, and
(ii) a second term that penalizes deviation between the modified label distributions assigned to input pairs of the target batch having similar features;
finding a set of modified label distributions that overall optimizes the unsupervised loss function across the target batch by aggregating the first and second terms over the target batch.

2. The method of claim 1, performed without modifying any parameter of the ML perception component.

3. The method of claim 1, wherein the target batch is unlabelled and the unsupervised loss function does not comprise any supervised term.

4. The method of claim 1, wherein the method is applied separately to multiple target batches, in order to optimize the respective labels for each target batch independently.

5. The method of claim 1, wherein the ML perception component comprises a feature extractor that computes a feature set for each input, the feature set used to compute the approximate feature distribution, wherein the second term of the loss function penalizes deviation between the modified label distributions assigned to input pairs of the target batch having similar feature sets as computed by the feature extractor.

6. The method of claim 5, wherein the loss function is defined as
$${ℒ}^{LAME} ( \tilde{Z} ) = {\sum }_{i} KL ( {\tilde{z}}_{i} ‖ {p}_{i} ) - {\sum }_{i , j} {w}_{i j} {\tilde{z}}_{i}^{T} {\tilde{z}}_{j}$$
where \tilde{Z} denotes the modified label distributions across the target batch, \tilde{z}ᵢ is the modified label distribution for perception input i, pᵢ is the approximate label distribution, and wᵢⱼ=w(ϕ(xᵢ), ϕ(xⱼ)), where ϕ(x) denotes the feature set for input x.

7. The method of claim 6, wherein the modified label distribution is computed iteratively, wherein in iteration n+1, the modified label distribution is computed based on the previous iteration n as:
$${\tilde{z}}_{ik}^{( n + 1 )} = \frac{{p}_{s} ( k \vert {x}_{i} ) exp ( - {\sum }_{j} {w}_{ij} {\tilde{z}}_{jk}^{( n )} )}{{\sum }_{{k}^{′}} {p}_{s} ( {k}^{′} \vert {x}_{i} ) exp ( - {\sum }_{j} {w}_{ij} {\tilde{z}}_{{jk}^{′}}^{( n )} )}$$
where k denotes a class and pₛ(k|xᵢ) is the probability of xᵢ belonging to class k according to the approximate label distribution.

8. The method of claim 1, wherein the plurality of perception inputs comprises correlated perception inputs received in at least one sensor data stream.

9. The method of claim 8, wherein the plurality of perception inputs comprises correlated images received in at least one video stream.

10. A computer system for classifying perception inputs of a target batch, the computer system comprising:
at least one memory storing computer-readable instructions; and
at least one processor coupled to the at least one memory and configured to execute the computer-readable instructions, which upon execution cause the at least one processor to:
in a label approximation phase, compute an approximate label distribution for each perception input in a plurality of perception inputs of the target batch using a trained machine learning (MIL) perception component, each perception input having parameters learned from training on a source training set, the approximate label distribution exhibiting error caused by a domain shift between the source training set and the target batch;
in an online label optimization phase, assign a modified label distribution to each input of the target batch, via optimization of an unsupervised loss function, the unsupervised loss function comprising:
(i) a first term that penalizes divergence between the approximate label distribution and the modified label distribution for each input of the target batch, and
(ii) a second term that penalizes deviation between the modified label distributions assigned to input pairs of the target batch having similar features:
find a set of modified label distributions that overall optimizes the unsupervised loss function across the target batch by aggregating the first and second terms over the target batch.

11. A non-transitory computer readable medium embodying computer program instructions, the computer program instructions configured, when executed on one or more hardware processors, to implement operations comprising:
in a label approximation phase, computing an approximate label distribution for each perception input in a plurality of perception inputs of a target batch using a trained machine learning (ML) perception component, each perception input having parameters learned from training on a source training set, the approximate label distribution exhibiting error caused by a domain shift between the source training set and the target batch;
in an online label optimization phase, assigning a modified label distribution to each input of the target batch, via optimization of an unsupervised loss function, the unsupervised loss function comprising:
(i) a first term that penalizes divergence between the approximate label distribution and the modified label distribution for each input of the target batch, and
(ii) a second term that penalizes deviation between the modified label distributions assigned to input pairs of the target batch having similar features;
finding a set of modified label distributions that overall optimizes the unsupervised loss function across the target batch by aggregating the first and second terms over the target batch.

12. The computer system of claim 10, performed without modifying any parameter of the ML perception component.

13. The computer system of claim 10, wherein the target batch is unlabelled and the unsupervised loss function does not comprise any supervised term.

14. The computer system of claim 10, wherein the computer-readable instructions are executed separately for multiple target batches, in order to optimize the respective labels for each target batch independently.

15. The computer system of claim 10, wherein the ML perception component comprises a feature extractor that computes a feature set for each input, the feature set used to compute the approximate feature distribution, wherein the second term of the loss function penalizes deviation between the modified label distributions assigned to input pairs of the target batch having similar feature sets as computed by the feature extractor.

16. The computer system of claim 15, wherein the loss function is defined
$${ℒ}^{LAME} ( \tilde{Z} ) = {\sum }_{i} KL ( {\tilde{z}}_{i} ‖ {p}_{i} ) - {\sum }_{i , j} {w}_{i j} {\tilde{z}}_{i}^{T} {\tilde{z}}_{j}$$
as
where \tilde{Z} denotes the modified label distributions across the target batch, \tilde{Z}ᵢ is the modified label distribution for perception input i, pᵢ is the approximate label distribution, and wᵢⱼ=w(ϕ(xᵢ), ϕ(xⱼ)), where ϕ(x) denotes the feature set for input x.

17. The computer system of claim 16, wherein the modified label distribution is computed iteratively, wherein in iteration n+1, the modified label distribution is computed based on the previous iteration n as:
$${\tilde{z}}_{ik}^{( n + 1 )} = \frac{{p}_{s} ( k \vert {x}_{i} ) exp ( - {\sum }_{j} {w}_{ij} {\tilde{z}}_{jk}^{( n )} )}{{\sum }_{{k}^{′}} {p}_{s} ( {k}^{′} \vert {x}_{i} ) exp ( - {\sum }_{j} {w}_{ij} {\tilde{z}}_{{jk}^{′}}^{( n )} )}$$
where k denotes a class and is the probability of xᵢ belonging to class k according to the approximate label distribution.

18. The computer system of claim 10, wherein the plurality of perception inputs comprises correlated perception inputs received in at least one sensor data stream.

19. The computer system of claim 18, wherein the plurality of perception inputs comprises correlated images received in at least one video stream.

20. The non-transitory computer readable medium of claim 11, performed without modifying any parameter of the ML perception component.
